(19) United States
(12) Patent Application Publication
(10) Pub. No.: US 2019/0277442 A1
(43) Pub. Date: Sep. 12, 2019

(54) ACCESSORY HOLDER FOR A WALL MOUNTED TV

(71) Applicant: Ilya Kandibur, Corona, CA (US)

(72) Inventor: Ilya Kandibur, Corona, CA (US)

(21) Appl. No.: 16/291,824

(22) Filed: Mar. 4, 2019

Related U.S. Application Data
(60) Provisional application No. 62/641,187, filed on Mar. 9, 2018.

(51) Int. Cl. F16M 11/20

(52) U.S. Cl. CPC F16M 11/2092; A47B 81/065; F16M 11/2085; F16M 11/2014

(57) ABSTRACT

Improvements accessory holder for a wall mounted TV for a time-saving, convenient method of installing electronics behind a wall-mounted TV without the need to attach directly to the TV itself. It provides a unique method for installing/removing and managing electronics installed behind a wall mounted TV. One or more plates with a variety of holes and mounts allow for accessories to be attached and removed from the TV mount, allowing for replacement and updating of electronics independent of the TV. Up to 6 mounting plates can be attached to the display mount at any one time. The mount attaches to the vertical bars of the display mount that physically attaches to the TV. This mount decouples from the TV itself and allows freedom of movement (left/right) to adjust and slide the TV along the horizontal bars of the display mount.

### CROSS REFERENCE TO RELATED APPLICATIONS

This application claims the benefit of Provisional Application Ser. No. 62/641,187 filed Mar. 9, 2018 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the invention

This invention relates to improvements in retaining accessories for a wall mounted TV. More particularly, the present accessory holder for a wall mounted TV that provides a universal bracket that is attachable to the back of a wall mounted TV or to the wall mount to hold accessories like cable boxes.

Description of Related Art including information disclosed under 37 CFR 1.97 and 1.98.

As TV's became thinner, they went from a desk or floor mount to a wall mount. Placing the TV on a wall eliminated the cabinet where the cable box, sound processor, and outlets could be placed or stored. While a cabinet can be placed under the TV, the optimal design will hide all of the support accessories of the TV behind the TV. The back of a TV and the wall mount usually have little or no structure for the variety of sizes and shapes for the support accessories. Most mounts use VESA mounts and is physically locked into a specific location on the TV. Any adjustment needed to the location of the TV on the mount requires complete removal of TV and mounting plate from the display mount.

A number of patents and or publications have been made to address these issues. Exemplary examples of patents and or publication that try to address this/these problem(s) are identified and discussed below.

U.S. Pat. No. 9,648,771 issued on May 9, 2017 to Leszek Markowski et al and is titled Multi-Piece Rack Shelf. The multi-piece shelf for an electronics rack, the electronics rack having a base and at least two vertical posts. The multi-piece shelf includes at least two side brackets and a removable shelf, the side brackets being separate components from the shelf. Each side bracket includes a vertical wall and a shelf mounting flange that is integral to and extends laterally from the vertical wall. A post mounting flange is integrally attached to at least a portion of the vertical wall for attaching to a vertical post. This rack is just a holder for an accessory. There is no structure for mounting the rack to the back of a TV.

U.S. Pat. No. 8,191,485 issued on Jun. 5, 2012 to Kenneth Whalen et al., and is titled Television Support and Mounting Kit. This patent discloses a universal TV support and mounting kit allows the consumer to employ any of the three modes of support, namely stand mount, console mount and wall mount. The console mount incorporates a vertical spine and a cantilever arm to support the television over the console. A mounting frame is provided that can be attached to the cantilever arm or to a wall. Pivoting and tilting is accommodated by the cantilever arm. While this rack supports TV accessories, the accessories are all visible below the TV.

U.S. Pat. No. D702,826 issued on Apr. 15, 2014 to Robert Schuter et al., and is titled Electronics Mounting Plate with a Universal Hole Pattern. This design patent is just a plate with a particular pattern of holes. It does not consider how the hole pattern would be located on the back of a TV nor does it consider mounting different TV support accessories.

What is needed is an accessory holder for a wall mounted TV where all of the support accessories can be mounted on the back of a television without being visible. The proposed accessory holder for a wall mounted TV provides the solution.

### BRIEF SUMMARY OF THE INVENTION

It is an object of the accessory holder for a wall mounted TV to be a time-saving, convenient method of installing electronics behind a wall-mounted TV without the need to attach directly to the TV itself. It provides a unique method for installing/removing and managing electronics installed behind a wall mounted TV. It is designed in a manner that hugs the back of an installed TV within a millimeter, thus allowing the wall-mounted TV to sit flush against the wall, as it would without any electronics attached behind it.

It is an object of the accessory holder for a wall mounted TV to be one or more plates that will be easily attached and removed from the TV mount, allowing for replacement of attached electronics, for reasons such as TV replacement/repair or replacing/updating electronics attached to the plate. Up to 6 mounting plates can be attached to the display mount at any one time. They can be arranged in various configurations, and added/deleted from the mount without ever removing components from the plate, or removing the TV from the bracket. The plates can be available in multiple sizes and have varying methods of attachment to the TV mounting bracket to work with a wider variety of mounts. The plate can be made of various materials (metal, plastic, composite, etc. . . . ) depending on the application and will have cut out patterns along its surface for wire management and attaching electronics to its surface. Modifying the design/look of the plate or hole pattern does not alter the utility of the design.

It is another object of the accessory holder for a wall mounted TV to be used with nearly any size TV, with or without Video Electronics Standards Association (VESA) patterns, since it does not rely on the VESA pattern for attachment. In a wide VESA configuration (600×400, 800×600, etc. . . . ) where the display mount brackets are toward the edges of the TV, this design allows for mounting the plates to the inside of those brackets at the center area of the TV. In this scenario, existing designs would have the plate protrude beyond the boundaries of the TV, as they cannot be mounted to the inside without conflicting with the display mount itself.

It is still another object of the accessory holder for a wall mounted TV to attaches to the vertical bars of the display mount that physically attaches to the TV. By doing so, it is decoupled from the TV itself and allows freedom of movement (left/right) to adjust and slide the TV along the horizontal bars of the display mount (if the display mount supports such function). The exact method of attachment of the mounting plate to the vertical bars is not important (screws or clamp) as display mounts vary, and this design may not be compatible with every display mount.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1A shows a plan view of a side mounting plate.

FIG. 1B shown a perspective view of the side mounting plate.

FIG. 2A shows a plan view of a center mounting plate.

FIG. 2B shown a perspective view of the center mounting plate.

FIG. 3 shows a TV wall mount with vertical and horizontal rails.

FIG. 4 shows three accessory brackets on the horizontal rails from the previous figure.

FIG. 5 shows mounting plates being installed on a horizontal rail.

FIG. 6 shows the three accessory brackets with the TV mount folded to the wall.

FIG. 7 shows options for six separate mounting plates using the horizontal rails.

FIG. 8 shows the back of a typical wall bracket, with no provision for attaching any additional electronics behind TV.

FIG. 9 shows the back of the TV from the previous figure with two mounting plates.

FIG. 10 shows the mounting plate from the previous figure with accessories mounted to the plates.

FIG. 11 shows an alternate embodiment of a side plate.

FIG. 12 shows an alternate embodiment of a center plate.

FIG. 13 shows an adjustable clamp.

FIG. 14 shows the clamp being used on a vertical rail.

FIG. 15 shows a first embodiment of a flat plate.

FIG. 16 shows a second embodiment of a flat plate.

FIG. 17 shows a corner bracket.

FIG. 18 shows the corner bracket in use.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

9 wall mount

20 side mounting plate

21 back plate

22 edge side

23 fastener hole

24 slot

25 opening

26 hole

30 center mounting plate

31 back plate

32 edge side

33 fastener hole

34 slot

35 opening

40 horizontal rail

41 vertical rail

42 hole

43 fastener(s)

50 TV mount plate

51 zip tie

52 cable box

53 internet box

54 power strip

55 Roku or similar

60 side mounting plate

61 back plate

62 edge side

63 fastener hole

64 slot

65 opening

68 flat surface

69 panel

70 center mounting plate

71 back plate

72 edge side

73 fastener hole

74 slot

75 opening

78 flat surface

79 panel

80 clamp

81 screw shaft

82 screw head

83 back surface

84 inside face

85 grip face

90 corner bracket

91 first side

92 perpendicular side

93 hole

94 slot

100 TV

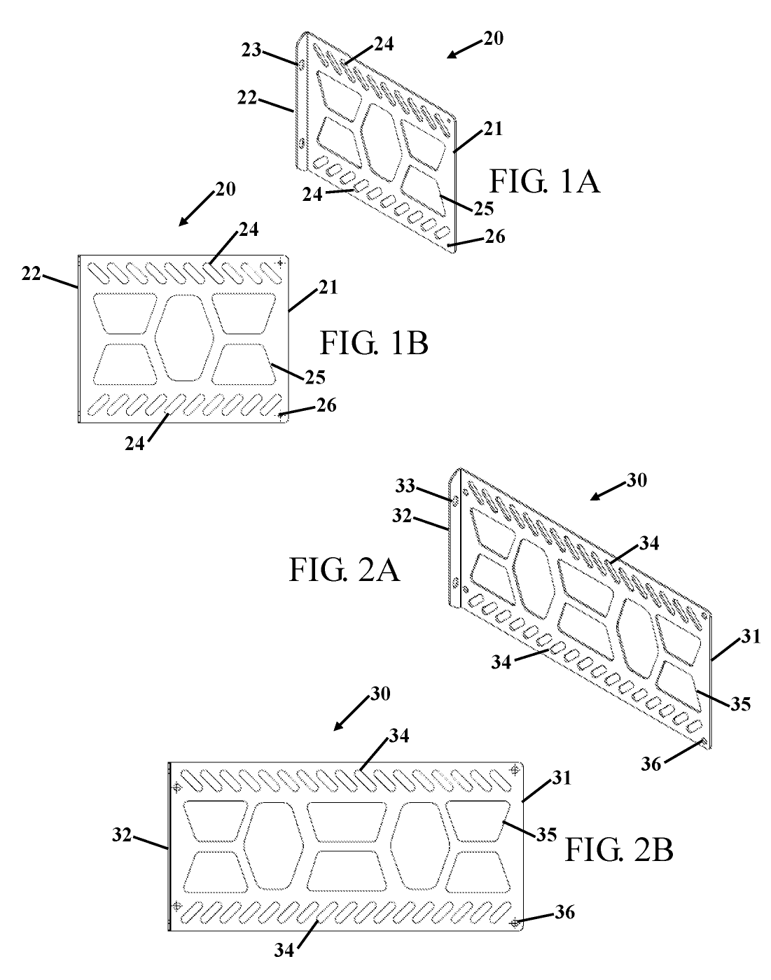

FIG. 1A shows a plan view of a side mounting plate 20, FIG. 1B shown a perspective view of the side mounting plate 20, FIG. 2A shows a plan view of a center mounting plate 30, and FIG. 2B shown a perspective view of the center mounting plate 30. N These are examples of two sizes of plates for this design. The actual hole pattern 24, 25, 34, 35, the look and the size of the mounting plates 20, 30 is not relevant to the utility of the design, and may not be the final shape and size. The edge 22, 32 that is bent perpendicular to the flat back plate 21, 31 respectively, and the method of attachment/detachment to the display mount is relevant. It can attach via screws through holes 23 or 33 in the edges 22, 32 if display mounts on vertical bars are supported, or via a grip that tightens around the plate edge 22, 32 on vertical bar to hold the mounting plates 20 and 30 together. The mounting plates 20 and 30 have a back plate 21, 31 flat surfaces with a bent side 22, 32. Alternative mounting holes 26 and 36 can be used to pass fasteners through the mounting plates 20, 30 to secure the mounting plates 20, 30.

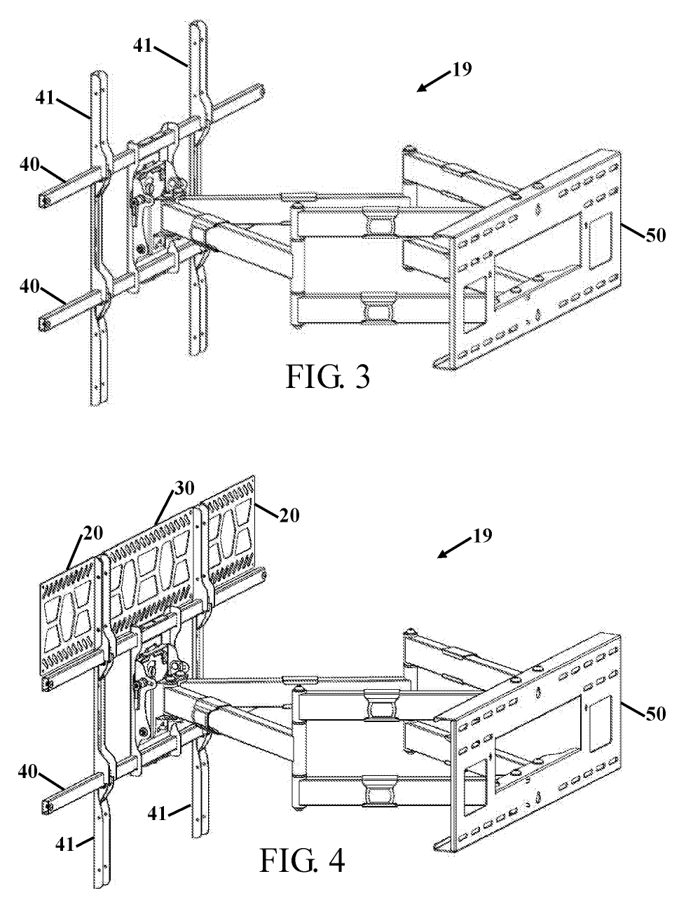

FIG. 3 shows a TV wall mount 19 with vertical 41 and horizontal rails 40. Installations of horizontal rails with a TV wall mount 19. In this figure, the mount for the TV mounting surface 50 is shown with the frame extended. The rails are positioned to remain clear of the existing TV mount and wall mounting features.

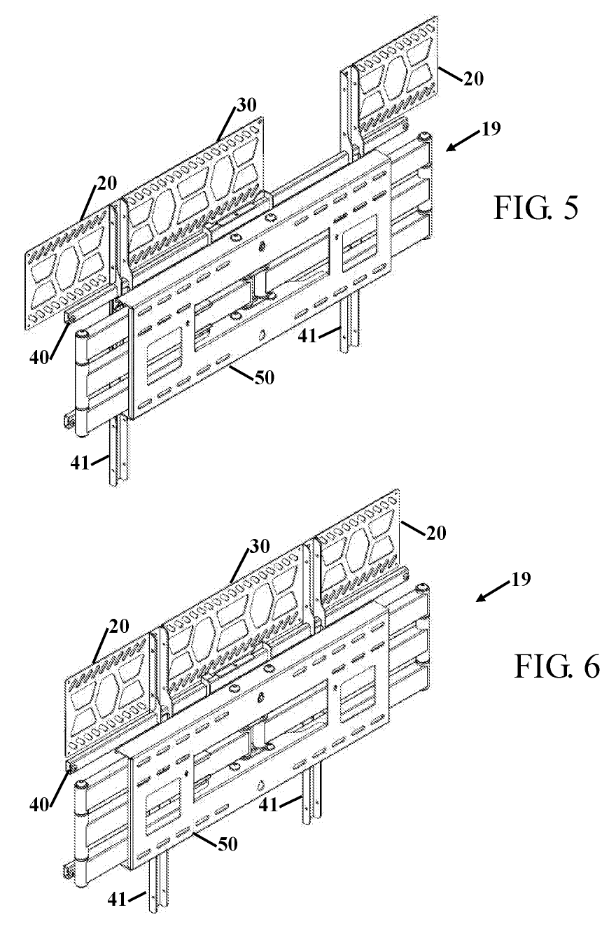

FIG. 4 shows three accessory brackets on the horizontal rails 40 from the previous figure and FIG. 5 shows mounting plates being installed on a horizontal rail 40, FIG. 6 shows the three accessory brackets with the TV mount 50 folded to the wall. These figures show a mounting bracket 20 on the left and right sides of the wall mount 19. A center mount plate 30 is mounted between the vertical rails 41. The specific mount is not relevant to this design. The method of attachment of mounting plate to display mount is relevant. There is no TV in this drawing and is relevant, as this method allows attachment independent of TV (unlike existing VESA mount or sandwiched designs). This design attaches to vertical bars 41 of the display mount.

This drawing shows the versatility of configuration for various VESA patterns. This design does not rely on VESA TV mounting pattern, thus is not limited by any of them. This design does not interfere with the arm mechanism of any display mount. In a comparison of FIGS. 5 and 6, the wide VESA pattern (800×400) and the standard VESA pattern (600×400), respectively is shown. The embodiment shown in these figure attaches to the vertical bars 41 of the display mount 19 that physically attaches to the TV. By doing so, it is decoupled from the TV itself and allows freedom of movement (left/right) to adjust and slide the TV along the horizontal bars of the display mount (if the display mount supports such function). Any plate that is VESA mounted or of a sandwiched design will not allow for this, as it is physically locked into a specific location on the TV. Any adjustment needed to the location of the TV on the mount requires complete removal of TV and mounting plate from the display mount 50. The exact method of attachment of the mounting plate to the vertical bars are not important (screws or clamp) as display mounts vary.

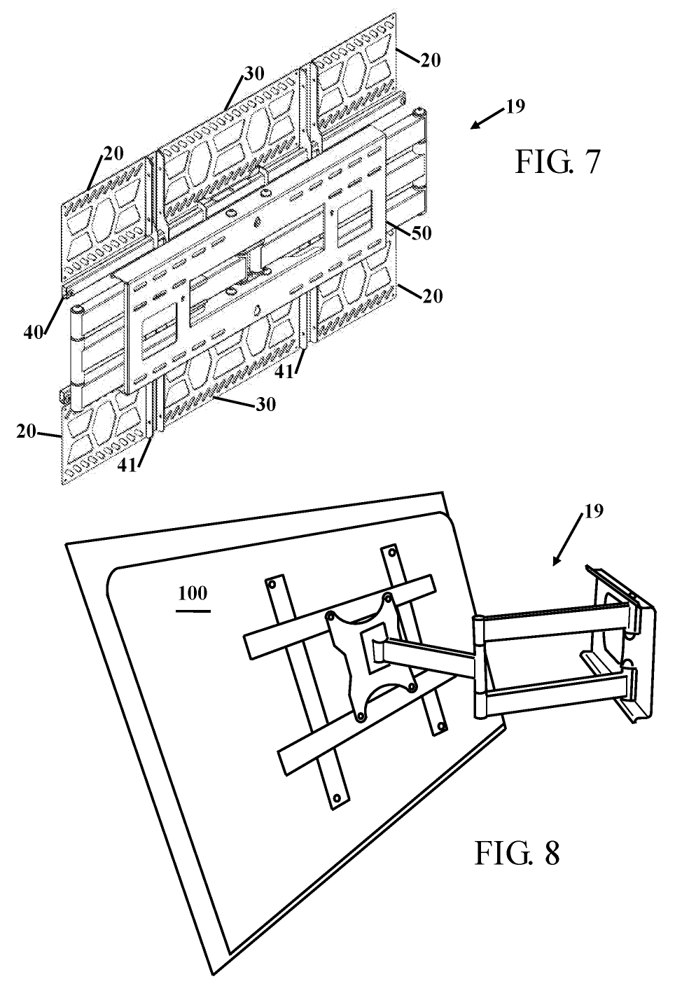

FIG. 7 shows options for six separate mounting plates 20, 30 using the horizontal rails. This is an embodiment of the wall mount 19, with a typical TV display mount plate 50 with four side mounting plates 20 on the left and right sides located both above and below the TV mounting plate 50. There are also two center mounting plates 30 above and below the TV mounting plate 50. The specific mount is not relevant to this design. The method of attachment of mounting plate to display mount is relevant. There is no TV in this drawing and is relevant, as this method allows attachment independent of TV (unlike existing VESA mount or sandwiched designs). This design attaches to vertical bars 41 of the display mount with horizontal rails 40. In this figure, the display mounting plate 50 is shown collapsed, to show that this design does not interfere with display mount extension arms and allows folding completely as designed with all 6 plates attached. While this figure shows 6 mounting plates, more or less than 6 mounting plates can be attached to the display mount at any one time. The quantity and locations of the mounting plates can be determined based upon the size of the TV and the amount/size of the support equipment that is needed. The mounting plates 20, 30 can be arranged in various configurations, and added/deleted from the mount without ever removing components from the plate, or removing the TV from the bracket.

FIG. 8 shows the back of a typical wall bracket 19, with no provision for attaching any additional electronics behind TV 100.

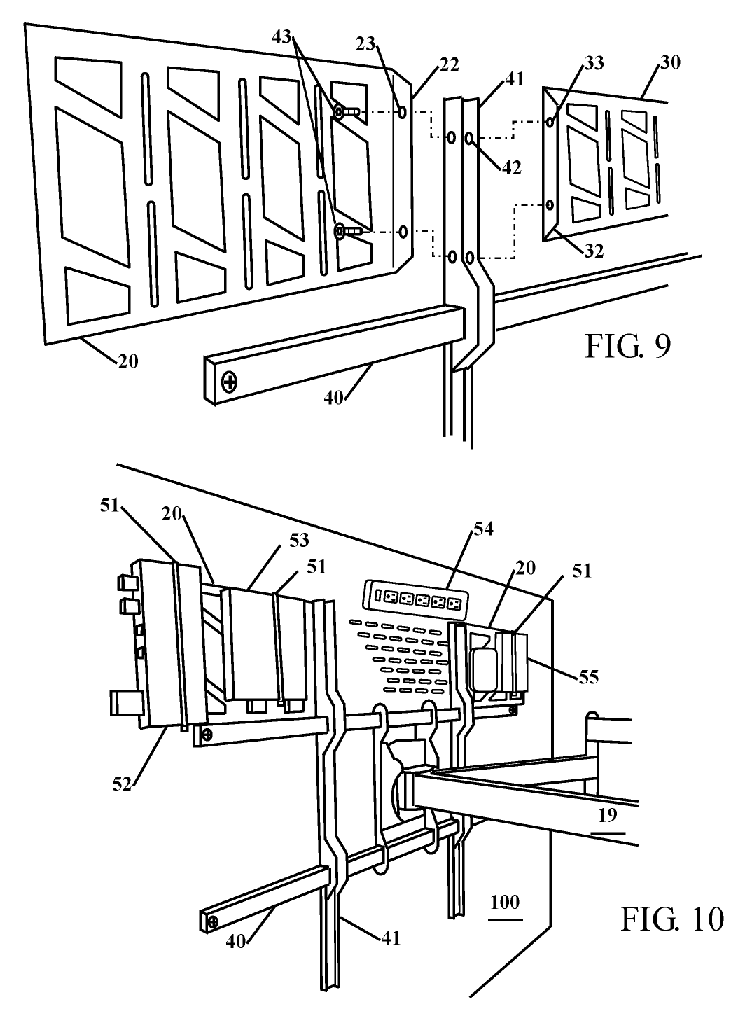

FIG. 9 shows the back of the mounting of mounting plates on vertical rails 41 that extend over or around the horizontal rails 40. This figure shows one contemplated embodiment with side mounting plate 20 and a center mounting plate 30. While this figure shows mounting screws 43 that pass through the holes 23, 33 in the edge sides 22, 32 other mounting and securing methods are contemplated. The fasteners 43 pass through holes 23 and into holes 42, and/or holes 33 and into holes 42 to secure the mounting plates 20 and 30. The mounting plates 20 and 30 can be secured separately or collectively with fasteners 43 that pass-through holes in both mounting plates 20 and 30. While this figure shows attachment via screws, but can be installed with a grip that tightens around the plate edge 22, 32 and vertical bar 41 to hold them together.

FIG. 10 shows the mounting plate 20 from the previous figure with accessories mounted to the plates. In this figure the thin mounting plates 20 are attached to display mount 19 for the purpose of attaching additional electronics. The entire TV 100 can still slide left/right on the vertical bar(s) 41, even with mounting plates 20 attached, as they are only connected to the vertical bars 41. Wiring and cables have been removed in this figure for clarity. The rear of the TV 100 in this installation shows mounting plates 20 secured to the vertical 41 and horizontal rails 40 on the wall mount 19 with electronics attached/installed.

In this embodiment the support electronics are a cable box 52, an internet box 53, a power strip 54 and a Roku® or similar device. While these support electronics are shown and described, it should be understood that they are examples and not requirements. Wire management can also be secured to the mounting plates as is (typical installation examples). Zip ties 51 or similar mechanism can be used to secure the support electronics to the mounting plates.

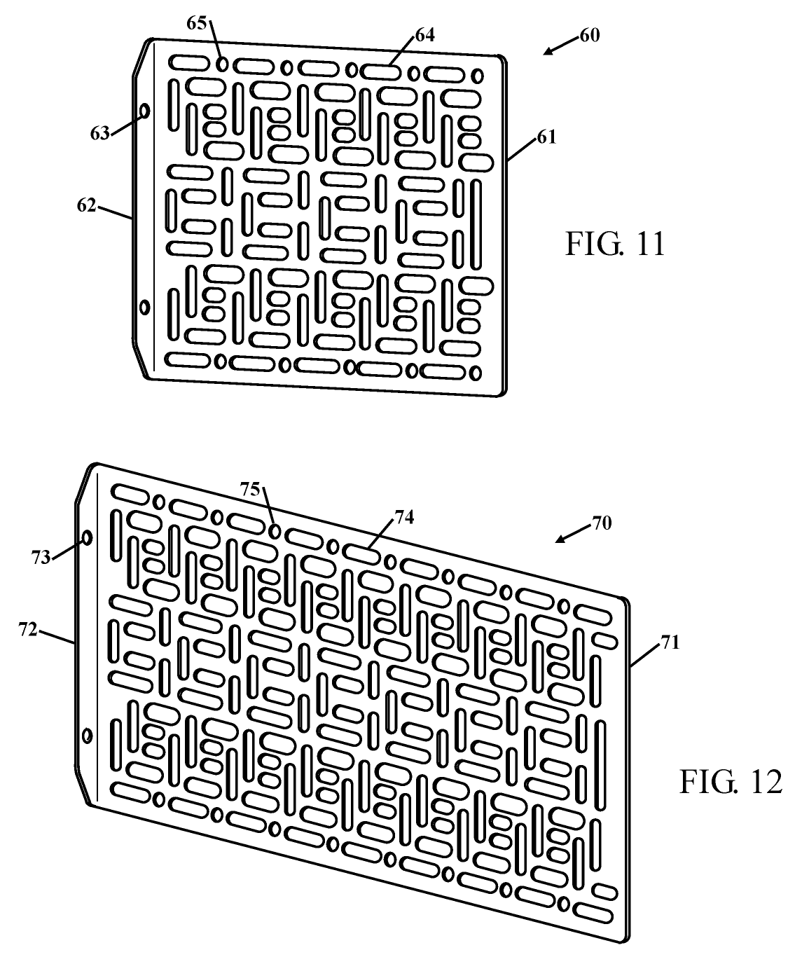

FIG. 11 shows an alternate embodiment of a side plate 60 and FIG. 12 shows an alternate embodiment of a center plate 70. These figures show alternative contemplated embodiments of two sizes of plates for this design. The actual hole pattern 65, 75, slot pattern 64, 74, look and size of the plate is not relevant to the utility of the design, and may not be the final shape and size. The edge 62, 72 of the plates 61, 71 and the method of attachment/detachment with holes 63, 73 to the display mount is relevant.

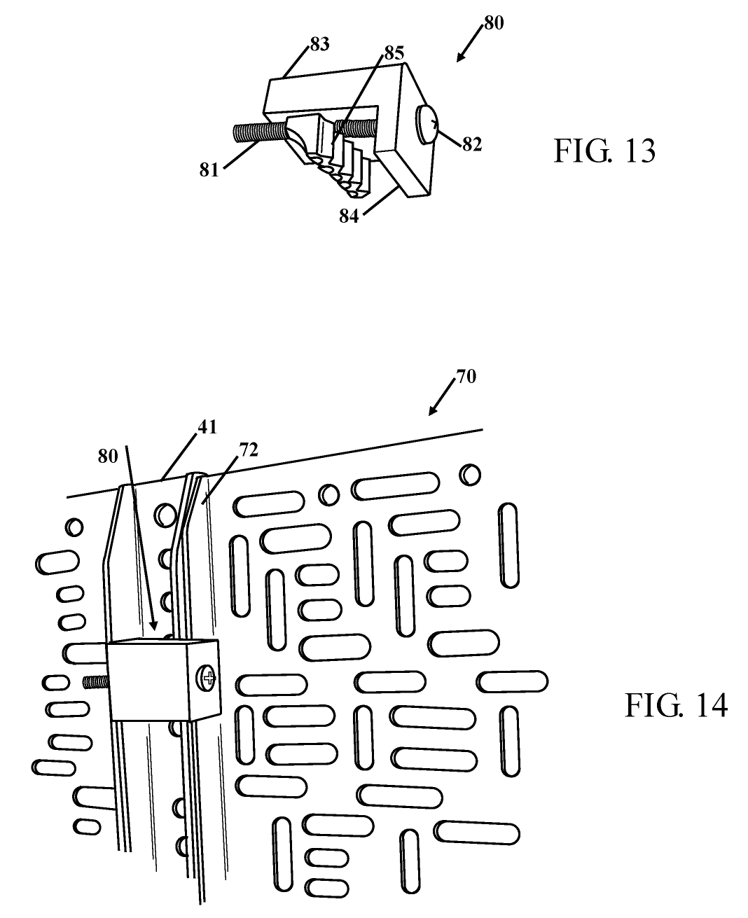

FIG. 13 shows an adjustable clamp 80 and FIG. 14 shows the clamp 80 being used on a vertical rail 41. The clamp 80 is essentially made from two housing pieces and a screw 82 that alters the distance between the clamping surfaces. The fixed housing has a base 83 with a perpendicular wall that has an inside face 84. The moving surface has a gripping face 85. The screw 82 passes from the back of the fixed housing and threads into the moving wall that alters the gripping surface 85 distance to the inside face 84. This allows a mounting plate 70 that has a bent edge side 72 of the mounting plate 70 be secured to a vertical rail 41 of a TV wall mount. The screw 82 of the clamp 80 can be positioned to pass through opposing holes in the vertical rail 41. While this is shown and described on a vertical rail, it can equally be used on a horizontal rail.

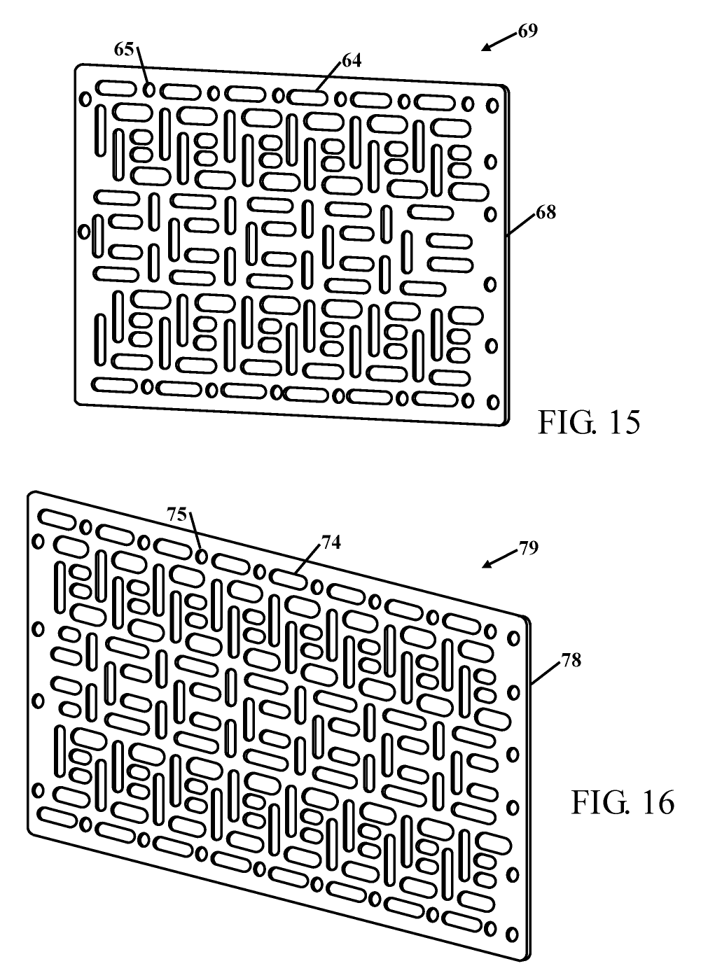

FIG. 15 shows a first embodiment of a flat plate 69 and FIG. 16 shows a second embodiment of a flat plate 79. These figures show alternative contemplated embodiments of two sizes of plates for this design. These plates do not have side flanges. Additional figures include a corner bracket for securing the flat plates to a TV wall mount. The actual hole pattern 65, 75, slot pattern 64, 74, look and size of the plate is not relevant to the utility of the design, and may not be the final shape and size.

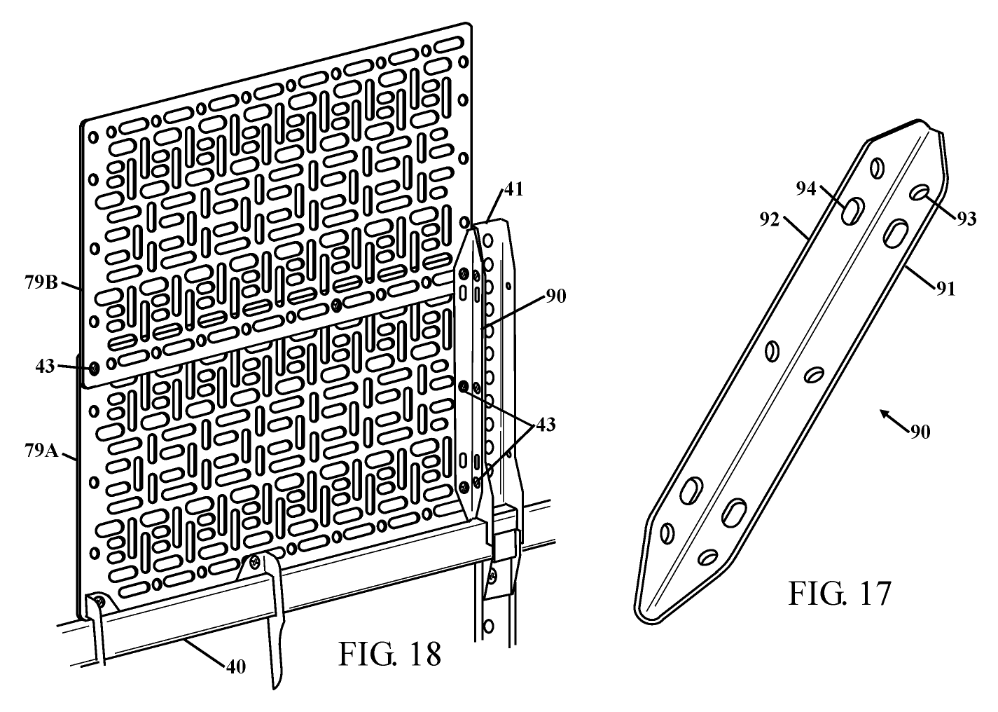

FIG. 17 shows a corner bracket 90 and FIG. 18 shows the corner bracket 90 in use. The corner bracket 90 creates a 90-degree bend between the two sides 91 and 92. The corner bracket 90 has a plurality of holes 93 and slots 94 for securing a flat plate (or an angled plate) to a frame or vertical rail 41 of a TO mount. The corner bracket 90 is shown securing a first flat panel 79A with fasteners 43. Additional panels 79B can be secured to one or more sides of the first panel 79A. Additional panels can be added as needed or desired to the top, bottom or sides to create a mounting surface of nearly an infinite size.

Thus, specific embodiments of an accessory holder for a wall mounted TV have been disclosed. It should be apparent, however, to those skilled in the art that many more modifications besides those described are possible without departing from the inventive concepts herein. The inventive subject matter, therefore, is not to be restricted except in the spirit of the appended claims.

1. An accessory holder for a wall mounted TV comprising:
a back plate;
said back plate further having at least one bent side that is bent perpendicular to said back plate;
said at least one bent side has at least one fastener hole, and
said at least one bent side is configured to mount on a flat TV wall mount with a vertical rail or a horizontal rail.

2. The accessory holder for a wall mounted TV according to claim 1, wherein said back plate has a plurality of openings.

3. The accessory holder for a wall mounted TV according to claim 2, wherein said plurality of openings includes at least two holes or slots.

4. The accessory holder for a wall mounted TV according to claim 3, wherein said at least two holes or slots provides a mounting for support hardware for a television.

5. The accessory holder for a wall mounted TV according to claim 2, wherein said plurality of holes allows at least a second back plate to be secured to said back plate.

6. The accessory holder for a wall mounted TV according to claim 5, wherein said second back plate is installable alongside, above or below said back plate.

7. The accessory holder for a wall mounted TV according to claim 1, further includes a corner bracket.

8. The accessory holder for a wall mounted TV according to claim 7, wherein said corner bracket allows said back plate to mount to an existing wall mount for a television.

9. The accessory holder for a wall mounted TV according to claim 8, wherein said support hardware is selected from the group consisting of a Roku®, a cable box, a tuner, a sound system, an internet interface or a power strip.

10. The accessory holder for a wall mounted TV according to claim 1, wherein said back plate is installed behind a wall mounted television.

11. The accessory holder for a wall mounted TV according to claim 1, wherein said vertical rail or said horizontal rail engages onto an existing wall mount for a television.

12. The accessory holder for a wall mounted TV according to claim 1, wherein said back plate sits flush against a wall.

13. The accessory holder for a wall mounted TV according to claim 1, wherein said back plate is installed and removed without removal of a television.

14. The accessory holder for a wall mounted TV according to claim 4, wherein said at least two holes or slots are configured in VESA patterns.

15. The accessory holder for a wall mounted TV according to claim 14, wherein said Video Electronics Standards Association (VESA) pattern is 600×400 or 800×600.

16. The accessory holder for a wall mounted TV according to claim 4, wherein said back plate exists behind a mounted television.

17. The accessory holder for a wall mounted TV according to claim 4, wherein said back plate extends beyond a mounted television.

18. The accessory holder for a wall mounted TV according to claim 1, wherein said back plate is not physically connect to a television.

19. The accessory holder for a wall mounted TV according to claim 1, further includes a clamp.

20. The accessory holder for a wall mounted TV according to claim 19, wherein said clamp secures said back plate to said vertical rail or said horizontal rail.
